(19) United States
(12) Patent Application Publication
(10) Pub. No.: US 2007/0179862 A1
(43) Pub. Date: Aug. 2, 2007

(54) EXHIBITOR ASSISTANT

(75) Inventors: Damon Armstrong, Carrollton, TX (US); Teresa Chao, Richardson, TX (US); Kirk Nativi, Frisco, TX (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: FREEMAN CAPITAL COMPANY, Las Vegas, NV (US)

(21) Appl. No.: 11/557,406

(22) Filed: Nov. 7, 2006

Related U.S. Application Data
(60) Provisional application No. 60/734,521, filed on Nov. 7, 2005.

(51) Int. Cl. G06Q 30/00

(52) U.S. Cl. 705/26

(57) ABSTRACT

Various embodiments of the present invention generally relate to systems and methods for assisting a user in presenting an exhibition booth at an exhibition. In particular, embodiments of the present invention relate to systems and methods for providing a user with a guided interface through which the user can arrange to purchase products and services from a provider that may assist in presenting an exhibition booth. The user may select booth features, carpet features, cleaning services, labor services in setting up and breaking down the booth, and furnishings.

### CROSS REFERENCE TO RELATED APPLICATIONS

The present application claims priority to U.S. patent application Ser. No. 60/734,521, filed on Nov. 7, 2005, entitled “Exhibitor Assistant,” which application may be incorporated herein by reference in its entirety.

### FIELD OF THE INVENTION

Various embodiments of the present invention generally relate to systems and methods for an exhibitor assistant. In particular, embodiments of the present invention relate to systems and methods for a guided interface for presenting a user with questions and, in response to the user's responses, guiding the user through a purchasing process.

### BACKGROUND OF THE INVENTION

Exhibition system ordering services may consist of many options which may be confusing to a first time or even experienced user. Assisting and guiding an exhibitor through the potentially confusing process of ordering services for an exhibition may be particularly labor intensive. For example, many systems only list the options and services available without any explanation about what the options mean or what the services entail, or illustrative representative examples. The charts of services and products may not have included precise definitions, guides, or examples to help the user select the proper rates. Exhibitors may find it difficult to determine the appropriate services which may be needed in combination with the products that are purchased. As a result, the exhibitor services or help desk personnel may spend a considerable amount of time answering exhibitor questions and guiding the exhibitor through the presented information and options. Or, even worse, the exhibitor may not purchase all of the products and services needed, causing problems and difficulties at a later time.

A need therefore exists for an automated system and method that helps an exhibitor to select appropriate items and services for setting up an exhibition booth and presenting at an exhibition or show.

### BRIEF SUMMARY OF THE INVENTION

One embodiment of the present invention may include an automated method for assisting a user in selecting products and services for presenting an exhibition booth that includes electronically soliciting information from a user relating to an exhibition booth to be displayed at an exhibition, the information solicited by providing questions to the user and receiving answers to the provided questions, the answers indicating selected products and services, electronically calculating a cost associated with presenting the exhibition booth based upon the provided answers, storing electronically the information provided by the user and the calculated cost, electronically soliciting additional information from the user relating to an exhibition booth to be displayed at an exhibition, the additional information solicited by providing questions to the user and receiving answers to the provided questions, the answers indicating additional selected products and services, electronically calculating an additional cost associated with presenting the exhibition booth based upon the additional information, and generating a summary of the costs and the selected products and services.

Another embodiment of the present invention may be an automated method for assisting a user in purchasing products and services for presenting an exhibition booth that includes electronically providing a first set of queries to a user relating to products and services for an exhibition booth to be displayed at an exhibition, receiving answers in response to the first set of queries, the answers indicating a choice of selected products and services related to displaying the exhibition booth, electronically calculating a cost based upon the selected products and services, presenting additional queries to the user for additional products and services and receiving answers to the additional queries, electronically calculating an additional cost based upon the answers to the additional queries, summarizing the cost associated with the first set of queries and the additional set of queries, and allowing the user to purchase the products and services for presenting the exhibition booth.

Another embodiment of the present invention may include a system for presenting a guided interface of questions for a user to select products and services relating to presenting a booth at an exhibition or show.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a block diagram displaying a flow chart of one embodiment exhibitor assistant of the present invention method.

FIGS. 2-18 illustrate exemplary embodiment screen shots of one embodiment of the present invention exhibitor assistant system.

### DETAILED DESCRIPTION

The present invention includes a system and method for a service provider to assist an exhibitor in purchasing and arranging the appropriate and necessary services for displaying a booth at a convention.

According to one embodiment of the present invention, an exhibitor assistant provides a guided interface for presenting the exhibitor with questions and, in response to the exhibitor's responses, guiding the exhibitor through a purchasing process. According to one embodiment, the exhibitor assistant may be used in conjunction with a structured exhibition system which may allow exhibitors to select appropriate items for an exhibition booth, calculate shipping costs, and the like. In other embodiments of the present invention the exhibitor assistant may provide the exhibitor with a structured system for selecting appropriate items for the booth. To this end, the exhibitor may be presented with questions and the exhibitor's responses to those questions may guide the exhibitor through the purchasing process.

In one embodiment, the questions, answers, and actions provided by the exhibitor assistant may be maintained by database administrators. The database administrators may provide questions that relate to products and services depending on the type and location of the show. In addition, the database administrators may need to adjust pricing structure depending on the show. In other embodiments, the database may be maintained in any manner desired. In some embodiments the system may access a service.

The present invention may be referred to herein as an “exhibitor assistant,” which refers generally to the entire system and method of presenting questions and information to the user and gathering information and responses from the exhibitor. The questions and information are presented to the exhibitor by a provider, who may be a provider of services that relate to an exhibition or show. The provider may be any company, individual, organization, show committee, or other group that may need a system and method for ameliorating the flow of information and selection of services by to and from users.

The term “exhibitor assistant” may be not intended to, and does not in any way, limit the scope of the present invention, but may be only convenient shorthand to reference all of the options, information, and selectable tools that are a part of the present invention system and method. Moreover, the present invention may be described in terms of a “booth” and an “exhibition.” Neither of these terms should be construed as limiting as “booths” and “exhibitions” can encompass a wide range of displays and presentations at conventions, meetings, shows, or other gatherings. The information, questions, and graphics may be presented on a “screen” or “page” that includes text, pictures, hyperlinks, and other characteristics as known in the art. The terms “screen” and “page” may be used interchangeably throughout the present description. Finally, the terms “exhibitor,” “user,” and “user” all are used to refer to an individual, group of individuals, or a company that may use or access the exhibitor assistant.

In the following description, numerous specific details are set forth in order to provide a thorough understanding of embodiments of the present invention. It may be apparent to one skilled in the art, however, that embodiments of the present invention may be practiced without some of these specific details. In other instances, well-known structures and devices may be added without changing the spirit and scope of the present invention.

Embodiments of the present invention may include a variety of steps as described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

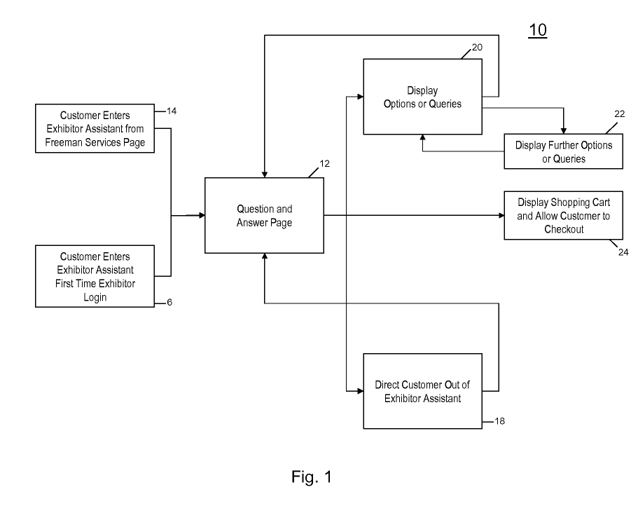

As illustrated in FIG. 1, an illustrative flow chart of one embodiment of an exhibitor assistant 10 according to the present invention may be set forth. This illustration may be not intended to be exhaustive, but rather to highlight some of the benefits and advantages associated with various embodiments and features of an exhibitor assistant 10.

The present invention may increase product and service sales by providing the user an intelligent pathway through the exhibition system ordering process. This intelligent pathway highlights and makes available the full suite of the exhibition products and services which are available for purchase without requiring a sales assistant to guide the user through every choice.

The user may enter a question and answer page 12 from at least two different start menus, including a home page 14 of the provider or from an exhibitor log in page 16. The home page 14 may include verbiage and a link prompting customers who need further assistance to enter the exhibitor assistant 10. In one embodiment, after a first time exhibitor has logged in and has entered any necessary information, a page may be displayed prompting the user to enter the exhibitor assistant 10 if desired.

Once the user has reached the question and answer page 12, the user may be queried with a series of questions and presented with a series of options as further described below. When the user enters information or selects options, the user may be presented with further options or queries 20. The further options or queries 20 may be based upon the answer or selection to the first question and answer page 12 or may be unrelated and just another query selected in order from the queue. In addition, when these options or queries are selected or answered then the user may be presented with still further options or queries 22 based upon the previously inputted information. Alternatively, if the line of inquiry may be at an end (as further described below), the user may be returned to the original question and answer page 12.

In other cases, when the user selects certain icons on the question and answer page 12, the user may be directed out of the exhibitor assistant 10 to a page 18 that may be part of the provider's network but may be not necessarily part of the present exhibitor assistant 10. For example, the user may select a link to be directed out of the exhibitor assistant 10 to gather other information from other pages 18.

Once the user has entered all of the required information and answered all of the required questions presented in the question and answer page 12, the user may be directed to an end page 24. The end page 24, as also further described below, may provide the user with a summary of the collected information, the selected services, and the costs for such services. The end page 24 may also include a user checkout section that allows the user to pay for and order the selected services and items that relate to the exhibition.

According to one embodiment of the present invention, the exhibitor assistant 10 may provide the user with one or more questions. Once the user provides responses to the questions presented by the exhibitor assistant 10, some action may be taken based on the response. Each question may have pre-defined answers from which the user may choose from a drop down list, a bulleted list, or the like.

In one embodiment, each answer may have an associated action or series of actions. When the user selects an answer with associated actions, the actions may be performed immediately or at a later time. In some embodiments, no action may be associated with one or more answers. For example, one instance where an action may not be associated with an answer may be when a user has answered “No” to a question. Therefore, some answers may not have any actions with which they are associated.

In other embodiments, other actions may need to wait until earlier actions have been fully completed. In still further embodiments, other actions may need to wait until the user reaches the end of the process to execute. According to one embodiment, the action queue helps maintain these action items until the correct execution time. In addition, if the answer to a question necessitates that an item may be added to the cart, the action may add the specified item to the cart. If the answer to a question requires displaying a selection of items from the catalog, this action may accomplish that task. If the answer to a question requires redirecting the user to an alternate location, this action may accomplish that task.

In some embodiments, since there may be times when a question may need to allow the user to select multiple answers, questions have an associated field denoting whether multiple answers can be selected for the question. For instance, a “question” could ask the user to “Please select the following services that you would like to view.” The user may then select multiple items and not just a single item.

In one embodiment, the exhibitor assistant 10 may maintain a list of questions to ask the user. In one embodiment, the list of questions may be maintained by using a question queue. The question queue may be initially populated when the exhibitor assistant 10 may be accessed by the user. As questions are asked they may be removed from the queue. In one embodiment, new questions may be added to the queue during the process as a result of answers provided by the user. According to one embodiment, when the question queue may be empty, the exhibitor assistant may be contemplated. As such, all remaining actions may be executed and the user may be given the choice of continuing to browse the catalog or be directed to the checkout area. In another embodiment, an additional application may be launched either by the user's choice or automatically.

According to one embodiment, answers are linked to a single question. There may be multiple answers for any given question, and, in some embodiments, a question must have at least two answers to be considered a valid question. If a question may be not valid, it may not be displayed to the user.

In one embodiment, when a question may be shown to the user, the associated answers may appear below the question. As previously mentioned, some questions allow for a single answer, while others may allow for multiple answers from the user. Depending on the question type, the answers may either have option buttons (single selection) or checkboxes (multiple selections) next to them. The user may select the desired option (or options) and submit those answers. Then, according to one embodiment, the appropriate actions may be added to the action queue.

After the answers to the questions have been stored, the actions in the action queue may start executing. In some situations, an action may execute which may require taking the user away from the exhibitor assistant 10 question and answer page. According to one embodiment, if the user may be taken away from the exhibitor assistant 10, any remaining actions in the action queue may be left in the queue and may be immediately executed before more questions are asked the next time the user returns to the question and answer page. This ensures that all actions are executed in the appropriate sequence.

In one embodiment, certain pages may be set such that when the user selects a single selection the user may be immediately taken back to the previous screen without being given the opportunity to select additional items from the category. This may be used, for example, when selecting a booth, carpet, or any other item of which there can be only a single selection.

According to another embodiment, certain pages may be set such that when the user may select multiple selections, the user may be asked whether or not they would like to select additional items. If the user chooses “Yes,” the user may be taken back to the catalog search page. If the user chooses “No,” the user may be taken back to the exhibitor assistant question and answer page. This may be used, for example, when selecting booth furnishings or any other items of which there can be multiple selections. Other selection type values may also be implemented by those of skill in the art.

According to one embodiment, systems and methods may also be provided for determining various business metrics. As such, whether or not the user uses the exhibitor assistant 10 to assist in purchasing one or more items, the items must be denoted for business metrics purposes. Such metrics may include whether or not the user used the exhibitor assistant 10 to purchase items for an order or show whether or not the user fully completed the process.

The information collected may be used, at least in part, to help determine how customers who use exhibitor assistant 10 buy products and services, versus customers who do not use exhibitor assistant 10. According to one embodiment, this information may also help determine if users are actually completing the exhibitor assistant 10 in its entirety, or exiting the exhibitor assistant prematurely.

In one embodiment, once a user has begun the exhibitor assistant 10, the user must finish the exhibitor assistant 10 or explicitly exit the exhibitor assistant 10. Accordingly, customers may not be taken out of the exhibitor assistant 10 when closing their browsers, logging off, etc.

Another feature of one embodiment of the present invention may include monitoring and reporting on sales figures, for example, figures related to those using the exhibitor assistant utility, and those who do not.

While, for convenience, embodiments of the present invention have been described for use in conjunction with existing software systems, other embodiments of the present invention may be equally applicable to other operational models. For example, the exhibitor assistant 10 described herein may be integrated with or form a part of a larger system relating to exhibition services. It may be further contemplated that embodiments of the present invention may be locally hosted. Alternatively, the software described may be distributed by exhibition organizers as an independent software package or utility which may be directly installed on the end user's computer.

The software may be developed using any capable source code. For example, the software package or utility could be developed in JAVA, “C++”, “C”, and the like. In another embodiment, all required coding may be Java 2 Platform, Enterprise Edition (J2EE) compliant. J2EE defines a standard for developing component-based multi-tier enterprise applications. Features of J2EE include Web services support and development tools (SDK).

As may be appreciated, the exhibitor assistant 10 may include options and elements that may only be presented if those services are available at a particular location or show. In addition, the exhibitor assistant 10 may be launched from various locations inside of a web based system, such as an order exhibition services page or a first time exhibitor login.

The functional design of various embodiments of the present invention may include one or more of a variety of features. Inevitably, the implementation of one or more of these designs may differ slightly from the description below, as these descriptions are meant to be exemplary and are by no means meant to cover every possible embodiment. As such, variations may be obvious to those skilled in the art without departing form the spirit and scope of the invention.

Following may be a list of exemplary Questions that may be asked during the course of the exhibitor assistant 10. As may be appreciated, other question scenarios may be implemented with a variety of levels, depending on the services provided by the provider and in response to the information entered by the user.

| 1. | Are both your booth size and show name correct? (Show company | | |
|---|---|---|---|
| | name on this page) | | |
| Yes | | | |
| No | Email notification to appropriate individual outlining issue. | | |
| 2. | Do you have your own exhibit? | | |
| Yes | 2.1. | Do you want to order carpet or request carpet samples? | |
| | Yes | Display carpet | |
| | | 1.1.1. | Do you want carpet padding or protective |
| | | | plastic covering (if not ordered already) |
| | | Yes | Display protective plastic covering/padding |
| | | No | |
| | No | | |
| | 2.2. | Do you want cleaning services? | |
| | Yes | 2.2.1. | Do you want carpet vacuuming or floor cleaning |
| | | | services? |
| | | Yes | Display vacuuming/floor cleaning services |
| | | No | |
| | | 2.2.2. | Do you want carpet shampooing service? |
| | | Yes | Display shampooing services |
| | | No | |
| | | 2.2.3. | Do you want porter services? (Describe |
| | | | Porter Services) |
| | | Yes | Display porter services |
| | | No | |
| | No | | |
| | 2.3. | Do you want Furnishing & Accessories? | |
| | Yes | Display page showing links to Furnishing and Accessory | |
| | | categories. Continue allowing user to select items from | |
| | | the catalog until the user indicates that they have finished | |
| | | selecting Furnishings and Accessories. | |
| | No | | |
| | 2.4. | Do you need Installation and Dismantling Labor? | |
| | Yes | Display page showing links to Display, Hanging Sign, | |
| | | and Rigging Installation and Dismantling Labor. | |
| | | Continue allowing user to select items from the catalog | |
| | | until the user indicates that they have finished selecting | |
| | | Labor items. | |
| | | Note: do not display hanging sign link if hanging sign | |
| | | may be not allowed. | |
| | No | | |
| | 2.10. | Do you want to estimate your Material Handling costs? | |
| | Yes | Redirect user to Material Handling Page | |
| | No | | |
| | 2.11. | Do you need Signs and/or Graphics? | |
| | Yes | Redirect user to signs and graphics information | |
| | No | | |
| | 2.12. | Do you need Exhibit Transportation Services? | |
| | Yes | Redirect user to Exhibit Transportation Page | |
| | No | | |
| No | 2.13 | Do you want to rent an exhibit? | |
| | Yes | Display Rental Exhibits (continue to question 2.14) | |
| | No | User will be taken to question 2.1 and will continue the | |
| | | Exhibitor Assistant from that location. | |
| | 2.14 | Do you want to upgrade your carpet? | |
| | Yes | Display carpet | |
| | | 1.1.1. | Do you want protective plastic covering or |
| | | | padding? (if not ordered already) |
| | | Yes | Display protective plastic covering/padding |
| | | No | |

| | |
|---|---|
| No | |
| 2.15 | Do you want porter services? |
| Yes | Display Porter Services |
| No | |
| 2.16. | Do you want Furnishing & Accessories? |
| Yes | Display page showing links to Furnishing and Accessory |
| | categories. Continue allowing user to select items from |
| | the catalog until the user indicates that they have finished |
| | selecting Furnishings and Accessories. |
| No | |
| 2.17. | Do you need any additional Labor? |
| Yes | Display page showing links to Display, Hanging Sign, |
| | and Rigging Installation and Dismantling Labor. |
| | Continue allowing user to select items from the catalog |
| | until the user indicates that they have finished selecting |
| | Labor items. |
| | Note: do not display hanging sign link if hanging sign |
| | may be not allowed. |
| No | |
| 2.18. | Do you want to estimate your Material Handling costs? |
| Yes | Redirect user to Material Handling Page |
| No | |
| 2.19. | Do you need Signs and/or Graphics? |
| Yes | Redirect user to signs and graphics information |
| No | |
| 2.20. | Do you need Exhibit Transportation Services? |
| Yes | Redirect user to Exhibit Transportation Page |
| No | |

### EXAMPLE

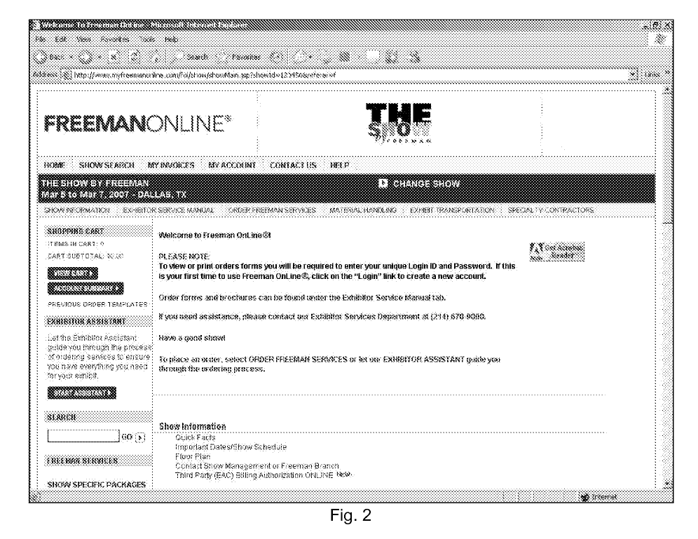

FIGS. 2-18 illustrate exemplary screen shots of one embodiment of the present invention exhibitor assistant 10. The pages and features of this example will be herein described from the perspective of a “customer” or a “user” who enters information and selects options. The user may be a user logging into the system through remote access or may be a user using software installed on the user's computer. Downloaded software may require uploading the inputted information to the provider after the information may be entered into the exhibitor assistant 10 by the user. In other embodiments, the information may be printed and faxed to the provider. The present example of one embodiment of the exhibitor assistant 10 may be described in terms of a user accessing the system through the internet.

Information may be entered and submitted on each screen by pressing the “NEXT” icon. In other embodiments this may, of course, be accomplished in a variety of ways. As may be appreciated, a number of different ways for the user to indicate that the information may be completely entered for that particular page may be utilized.

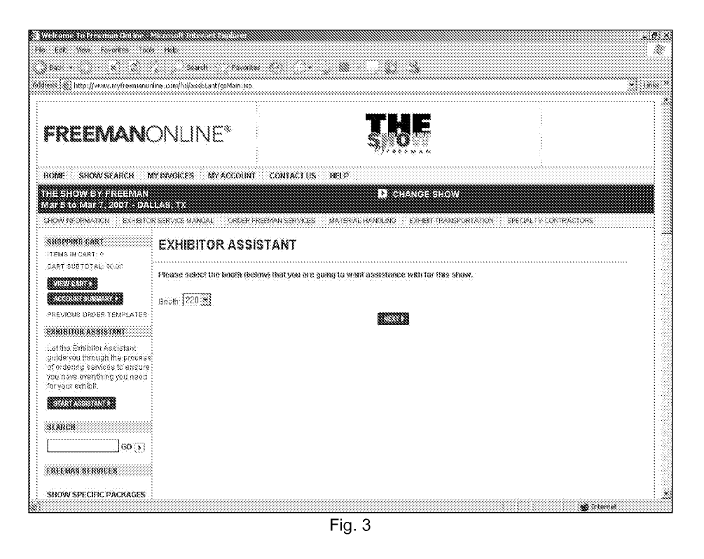

A first page may be illustrated in FIG. 2. The page illustrated in FIG. 2 may provide the user access to the exhibitor assistant 10 from another page in the provider's web access. The user may select the “Start Assistant” icon to enter the exhibitor assistant 10. As illustrated in FIG. 3, an example first page of the exhibitor assistant 10 may present the first question. In further embodiments, the first page of the exhibitor assistant 10 may be preceded by a welcome page or a page including instructions and relevant information in addition to a page for the user to log into the system. Such a log in may be password protected to protect the user's confidential information.

In one embodiment, the user may first be presented with a list of different shows or exhibitions for which the provider may be providing services. Such information may also be presented in a standard drop down menu format. The selection of an exhibition or show by the user may allow the exhibitor assistant 10 to provide the correct question queue and to input the correct numbers and other information in response to the user's selections. In embodiments where the software may be downloaded or provided for a specific exhibition, the input of the proper numbers and information for that show may already be accomplished. As shown, the information initially requested in the present embodiment may be the booth space that the user may be occupying at the selected exhibition.

Many of the selectable icons shown on the screen in FIG. 3 may remain the same throughout the present embodiment system. Generally, the information under the heading “EXHIBITOR ASSISTANT” may change from screen to screen. The information on the left and top of the page may flow through many or all of the pages.

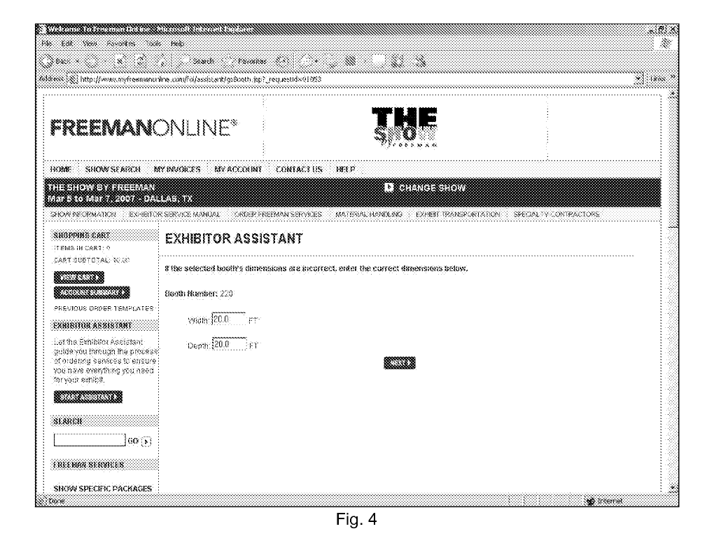

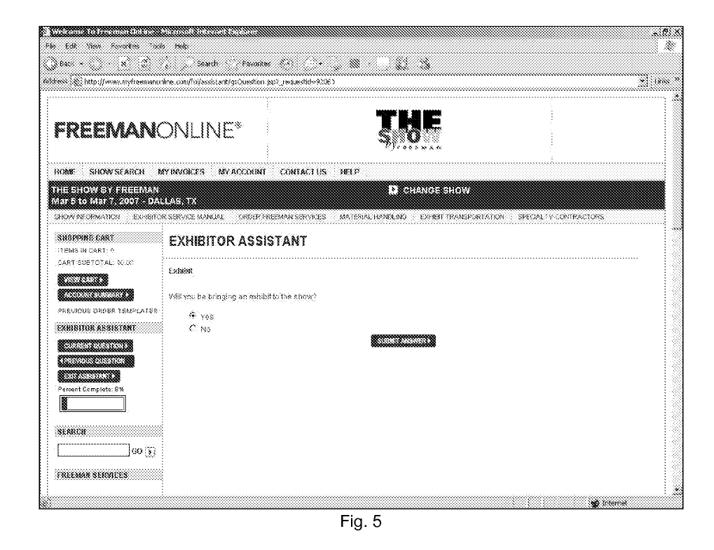

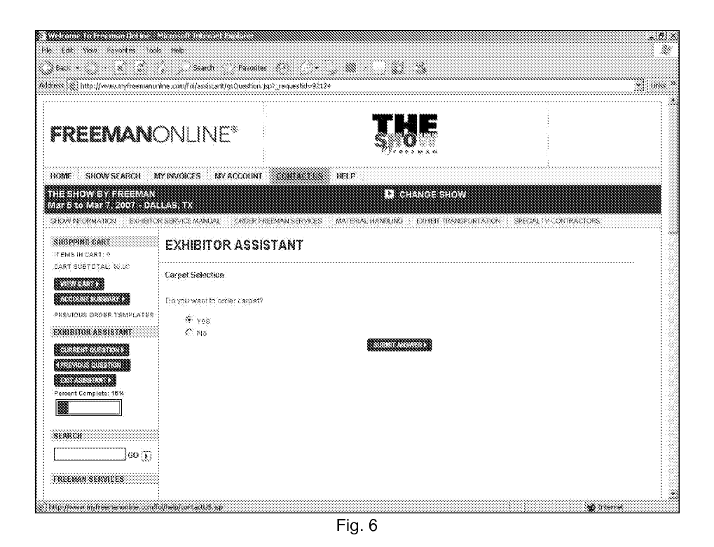

FIG. 4 may present the dimensions of the booth selected in FIG. 3. This information may be presented from the provider's database and confirmed by the user. Once the information may be corrected, if necessary, the user may proceed to FIG. 5. In the present embodiment, the information presented by the system in FIG. 5 may not be prompted from the information entered in FIG. 4, but may be rather a new line of inquiry. In the present case the query may be as to whether the user may be bringing an exhibit to the show and may be answered by a simple “Yes” or “No” answer. A “No” answer to this question may prompt the user to construct an exhibit using another part of the exhibitor assistant 10. Such a tool may provide the user with choices relating to stock exhibits or customizable exhibits with a variety of features. A “Yes” answer may lead the user to a page as shown in FIG. 6.

As illustrated in FIG. 5, selectable icons and links may direct the user to the current question or the previous question may help the user to navigate the system. As may also be illustrated, a “Percent Complete” tool may indicate to the user how much of the exhibitor assistant 10 has been completed and how much still remains. The user may also select “View Cart” or “Account Summary” to receive information relating to the products and services that the user has already selected. Other navigation features may be added by those of skill in the art without changing the spirit and scope of the present invention.

The navigation section may also allow users to move around the site freely and easily return to the exhibitor assistant 10 when desired. In other embodiments, the navigation section may display a visual indicator as to how much progress the user has made through the exhibitor assistant 10.

Some embodiments allow for the user to click on the current question button to return to the question and answer page from any page in the system. Clicking the previous question button may take the user back to the previous question. In one embodiment, when a user clicks the “Exit” button, the user may be prompted to confirm a desire to exit. The message may indicate that the customer has not yet finished the exhibitor assistant and may have to restart the exhibitor assistant 10 if the customer chooses to exit at that point in time.

According to one embodiment, when the user has exited the exhibitor assistant 10 after the system may be completed, the exhibitor assistant 10 navigation section may no longer appear.

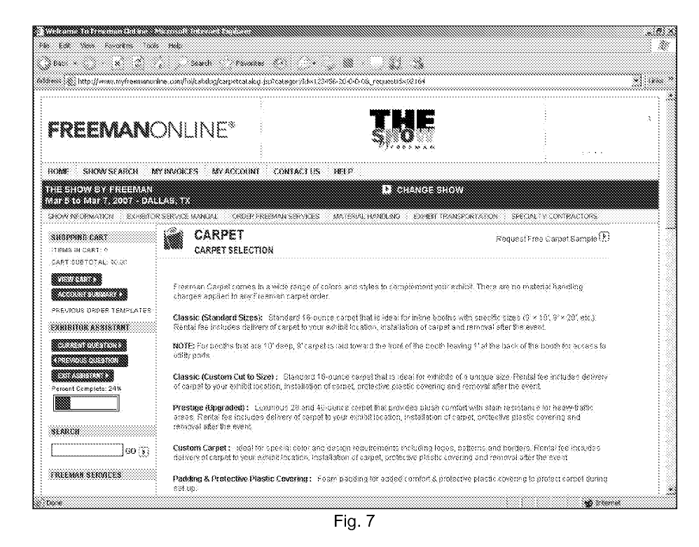

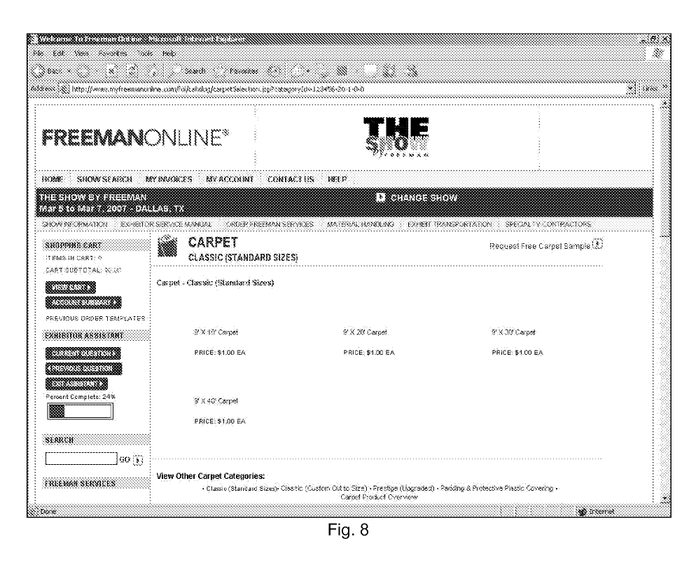

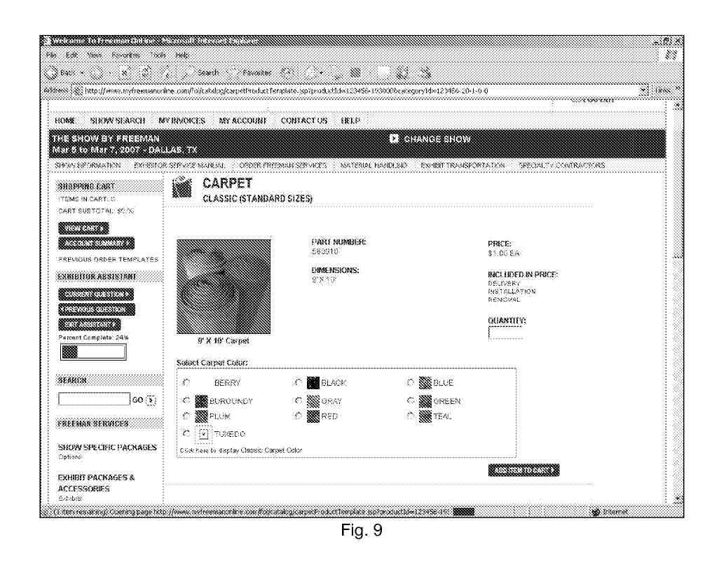

FIG. 6 may illustrate a query asking whether the user would like to order carpet. The query regarding carpeting may or may not depend on the already inputted information. If the user decides to order carpet, the system may direct the user to another series of questions, as illustrated in FIGS. 7-9, which illustrate choices that may be made in view of the answer to the original query in FIG. 6. As shown in FIG. 7, a variety of selectable options may be presented that include a description of each option. The description presented with each option may enable the user to make a more informed selection from the presented choices. Once a selection may be entered the user may be presented with further choices based on that selection, as shown in FIG. 8. In the present embodiment shown, the type of carpet may be selected. Still further choices may also be presented based on the next selection as shown in FIG. 9. In the present embodiment shown, the size of the selected carpet may be shown. Other options that may be presented include the selection of carpet padding or carpet related services.

As may be appreciated, a number of inquiries for further information may be made in response to selections entered on almost any of the exhibitor assistant 10 pages or screens presented by the current embodiment system.

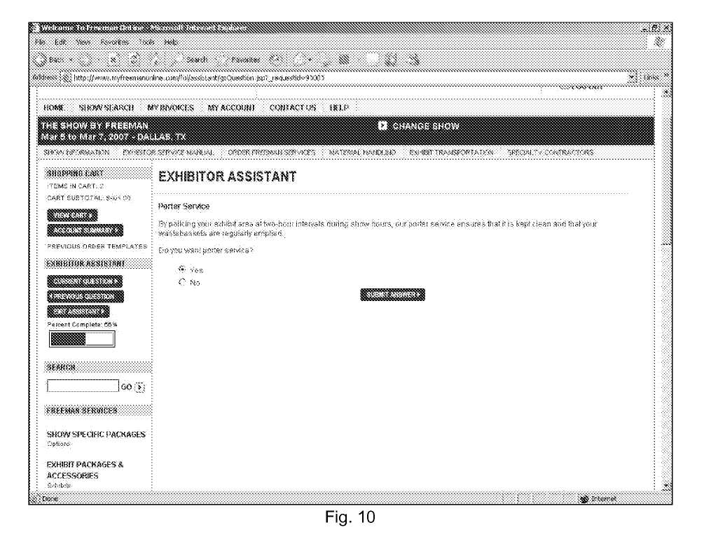

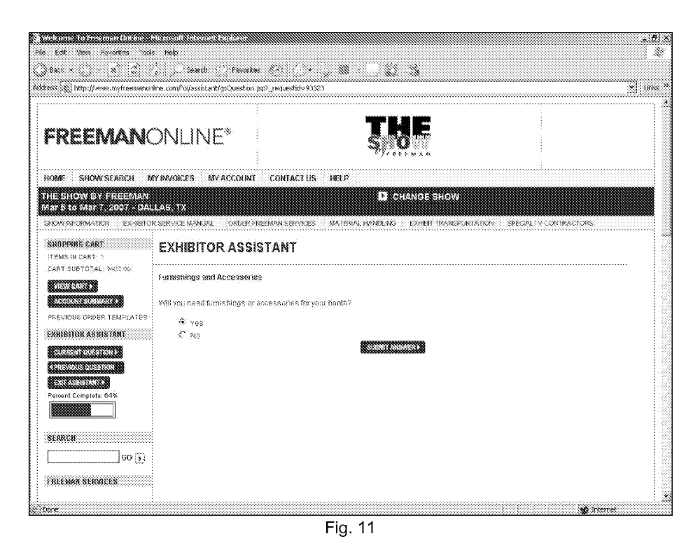

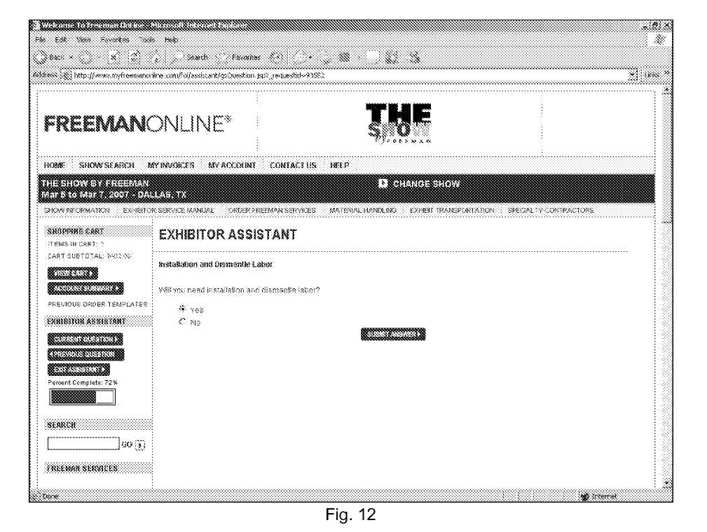

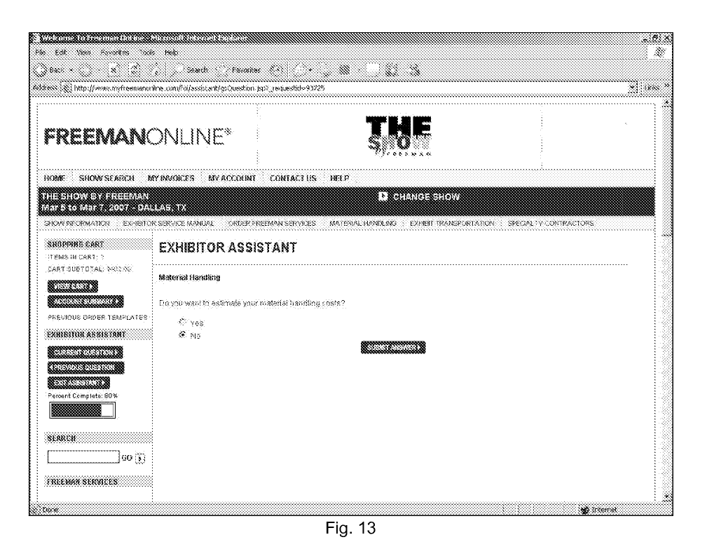

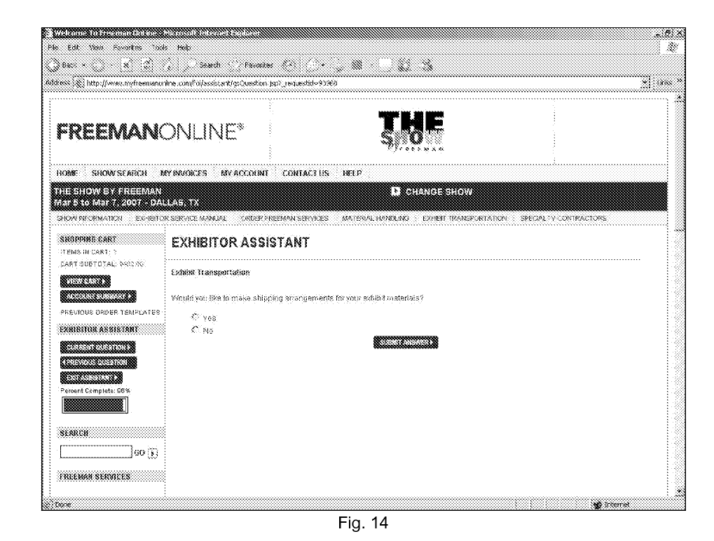

FIGS. 10-14 illustrate further example queries for information and example options for selectable services that may be presented by the present embodiment exhibitor assistant 10. The example questions illustrated include whether the user wishes for a cleaning service to police the exhibit area (FIG. 10), whether furnishings for the booth are required (FIG. 11), whether installation and dismantling labor may be required (FIG. 12), whether the user desires an estimate of material handling costs (FIG. 13), and whether shipping arrangements are going to be made through the system (FIG. 14). If the user selects the option to estimate material handling costs, the user may be diverted to a system that may be described in U.S. Provisional Application No. 60/734,520, and the co-pending U.S. Utility application entitled “Material Handling Calculator,” application No. ______, filed concurrently with the present application, which are both incorporated herein by reference in their entirety.

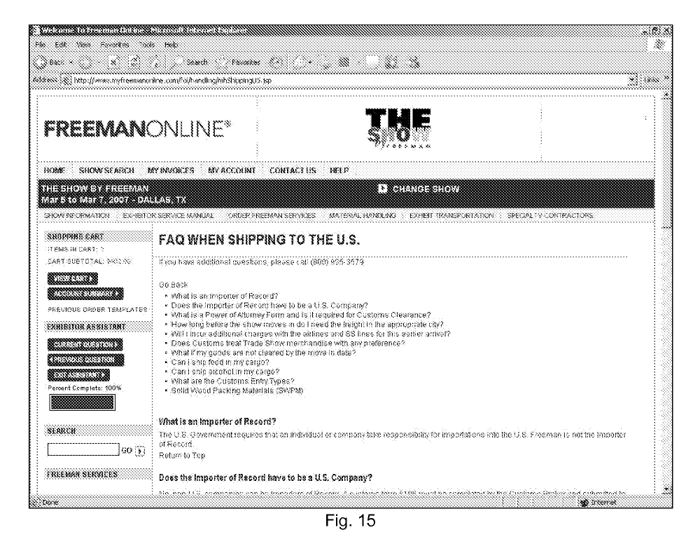

As with many of the queries presented herein, if the user indicates a certain response the user may be guided through a series of other screens that present further options based on the original and subsequent selections. In FIG. 14, for example, if the user desires to make shipping arrangements the user may be diverted to a number of screens that collect the required information for shipping, such as may be illustrated in FIG. 15. Each of these questions may be linked to answers and further information that can be presented and selected to the user. Likewise, if furnishings are selected in FIG. 11, a number of options and descriptions may be presented, with each option leading to more options and descriptions. Further screens may allow the user to proceed through the system and the provider to offer a guided sell to the user such that options are presented by the provider and selected by the customer.

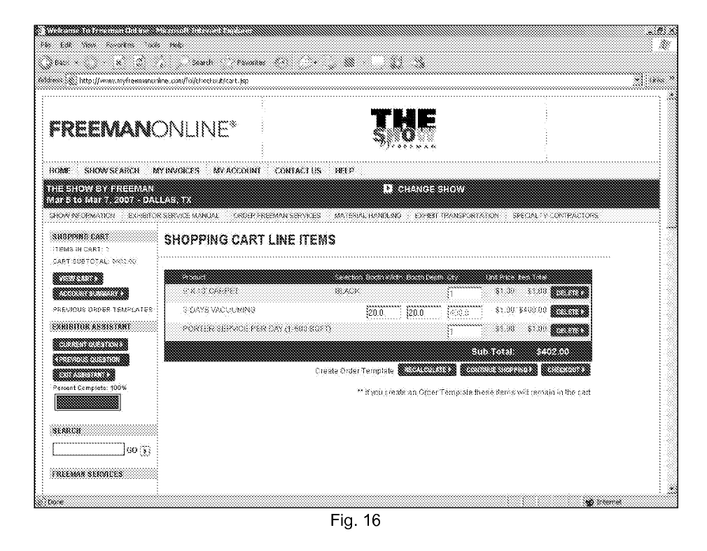

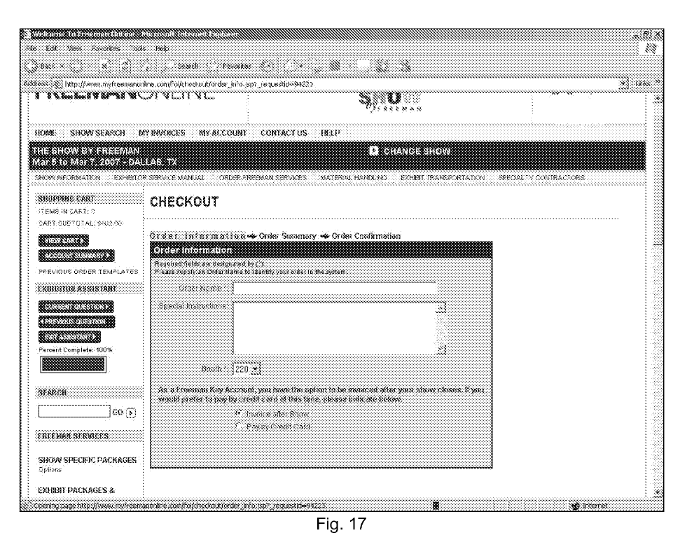

Once the services and other items are selected by the user from the system, the user may be presented with a “shopping cart” page, as illustrated in FIG. 16, in which the selected items and services may be summarized along with the cost breakdown. As may be appreciated, such a page may be formatted and presented in a number of different ways. A screen for checking out may be illustrated in FIG. 17.

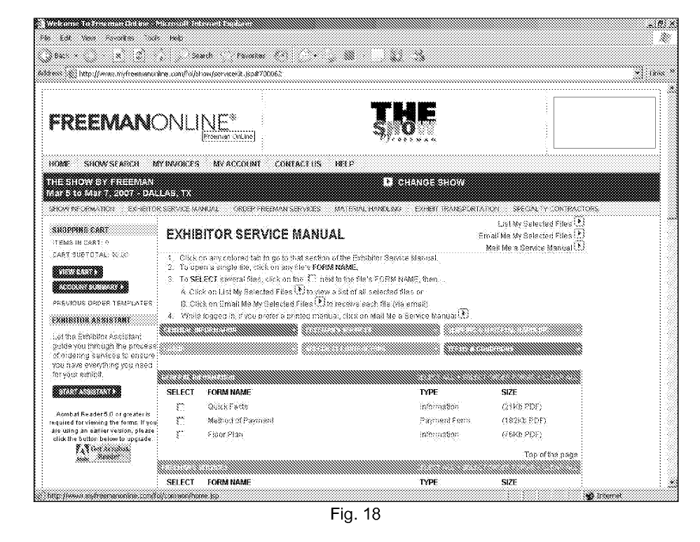

An additional screen that may be helpful to a user of the present embodiment system may be illustrated in FIG. 18. Such a screen may present a number of information links specific to each show. Such information may include payments plans, floor plans, information about the system, and information about the show. Again, a selectable menu may present the user with further information or further choices.

Other additional screens presented by the present embodiment system may include options for carpeting, plastic coverings for carpeting, other cleaning services such as vacuum or carpet shampooing, garbage disposal, installation services for equipment, signs, and displays, and shipping labels. In further embodiments still further screens may be presented that present further questions or provide additional items for selection without changing the spirit and scope of the present invention.

In one embodiment, when the exhibitor assistant 10 question page loads, it may check to see if it needs to load a question, or a question group. According to one embodiment, question groups may be denoted by a special set of question queue bookmarks that may surround all of the questions that need to be displayed together on a page. If no question group needs to be loaded, then the page may display the first question, and only the first question, in the question queue. If a question group does need to be loaded, then the page may display all of the questions in the question queue until it finds the group end question queue bookmark.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention may be intended to embrace all such alternatives, modifications, and variations as fall within the scope of the claims, together with all equivalents thereof.

We claim:

1. An automated method for assisting a user in selecting products and services for presenting an exhibition booth comprising:
electronically soliciting information from a user relating to an exhibition booth to be displayed at an exhibition, the information solicited by providing questions to the user and receiving answers to the provided questions, the answers indicating selected products and services;
electronically calculating a cost associated with presenting the exhibition booth based upon the provided answers;
storing electronically the information provided by the user and the calculated cost;
electronically soliciting additional information from the user relating to an exhibition booth to be displayed at an exhibition, the additional information solicited by providing questions to the user and receiving answers to the provided questions, the answers indicating additional selected products and services;
electronically calculating an additional cost associated with presenting the exhibition booth based upon the additional information; and
generating a summary of the costs and the selected products and services.

2. The method of claim 1 wherein soliciting information further comprises presenting the user with a list of selectable options.

3. The method of claim 2 wherein the user may select only one of the options.

4. The method of claim 1 wherein electronically soliciting additional information further comprises providing questions to the user based upon the answers previously provided to previous questions.

5. The method of claim 1 electronically soliciting information from the user further comprising providing questions relating to the size of the booth to be presented.

6. The method of claim 1 electronically soliciting information from the user further comprising providing questions relating to additional labor may be required for presenting the booth.

7. The method of claim 1 electronically soliciting information from the user further comprising providing questions relating to arranging shipping costs for the exhibition booth.

8. An automated method for assisting a user in purchasing products and services for presenting an exhibition booth comprising:
electronically providing a first set of queries to a user relating to products and services for an exhibition booth to be displayed at an exhibition;
receiving answers in response to the first set of queries, the answers indicating a choice of selected products and services related to displaying the exhibition booth;
electronically calculating a cost based upon the selected products and services;
presenting additional queries to the user for additional products and services and receiving answers to the additional queries;
electronically calculating an additional cost based upon the answers to the additional queries;
summarizing the cost associated with the first set of queries and the additional set of queries; and
allowing the user to purchase the products and services for presenting the exhibition booth.

9. The method of claim 8 further comprising selecting the additional queries in response to the received answers to the first set of queries.

10. The method of claim 8 wherein electronically providing a first set of queries further comprises electronically sending a page over the internet viewable by the user.

11. The method of claim 8 further comprising the user downloading and installing software onto the user's personal computer.

12. The method of claim 8 wherein electronically providing a first set of queries further comprises providing the user with queries relating to one or more of exhibit numbers, exhibits, carpet, cleaning services, furnishings, shipping costs, or labor.
